(19) United States
(12) Patent Application Publication
(10) Pub. No.: US 2007/0058999 A1
(43) Pub. Date: Mar. 15, 2007

(54) Image forming device

(75) Inventor: Kozo Tao, Osaka (JP)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Kyocera Mita Corporation

(21) Appl. No.: 11/221,975

(22) Filed: Sep. 9, 2005

(51) Int. Cl. G03G 15/00

(52) U.S. Cl. 399/38

(57) ABSTRACT

An image forming device includes a printing unit for carrying out a print job, a calibration unit for calibrating the printing unit, a control unit for making the calibration unit calibrate after the end of the print job under the condition that the number of printed pages since the latest calibration enters a predetermined calibration range.

### BACKGROUND OF THE INVENTION

1. Field of the Invention

The present invention relates to an image forming device.

2. Description of Related Art

In an operation of process color printing devices, it is common to carry out calibration to prevent a change in color density due to developing or environmental changes, and to maintain tone reproduction, periodically or under a predetermined trigger condition. The word “calibration” means an operation consisting of printing the preset pattern to a drum or a medium transcriptional body without printing on paper, detecting the color density using sensors, and adjusting the printing process based on the difference between the color density detected by the sensors and the predetermined color density.

An image processing device which is capable of selecting the timing of calibration from among instantly, after a print job, with respect to the number of pages left to be printed, and automatically (depending on the number of prints) is known (see for example, Japanese Unexamined Patent Application, First Publication No. H10-114128). In addition, a device which calibrates before printing (see for example, Japanese Unexamined Patent Application, First Publication No. 2000-227684), and a device which divides a print job according to information on the timing of calibration (a number of prints between calibrations) and calibrates before each divided print job (see for example, Japanese Unexamined Patent Application, First Publication No. H11-157177) are also known. Furthermore, a device which calibrates before printing when the device processes color printing and calibrates after the print job or a predetermined number of prints when the device processes monochrome printing (see for example, Japanese Unexamined Patent Application, First Publication No. 2000-324279), and a device which keeps print jobs waiting (expanding PDL to image data regardless of calibration) during calibration and prints after calibration (see for example, Japanese Unexamined Patent Application, First Publication, No. 2004-074561) are known.

Some image forming devices which need calibration have to accurately calibrate every determined number of printed pages because of limitations of the process. In such devices, there are cases in which calibration is carried out during a print job, because the user does not take into account the predetermined number of printed pages and the predetermined number is reached during the print job. In the case where a device prints more than the predetermined number, it is inevitable that calibrations are carried out during the print job. However, since calibration is also carried out during a print job of only a few sheets of paper, it takes longer to complete the print job, which is burdensome to the user. Furthermore, because calibration during a print job changes the quality of the prints before and after calibration, users sometimes have to print again to obtain prints of consistent quality.

### SUMMARY OF THE INVENTION

The present invention provides an image forming device including a printing unit which processes print jobs, a calibration unit which carries out calibration, and a control unit which makes the calibration unit carry out calibration after a print job when a number of printed pages after the latest calibration enters a range of calibration.

The present invention enables optimization of the timing of calibrations. Because the optimization contributes to reducing the frequency of calibration during print jobs, it makes it possible to maintain the quality of prints in print jobs.

The control unit may be one which stops the print job and makes the calibration unit calibrate when the number of printed pages since the latest calibration becomes equal to a predetermined calibration number during the print job.

The present invention provides an image forming device including a printing unit which processes a print job, a calibration unit which carries out calibration, a determining unit which determines the number of pages needed to be printed in the print job, and a control unit which makes the calibration unit carry out a calibration before printing when a printed page number, namely a number needed to be printed in the print job added to a number of printed pages since the latest calibration, becomes greater than the predetermined number for calibration.

The present invention enables optimization of the timing of calibration. Because the optimization contributes to reducing the frequency of calibration during print jobs, it makes it possible to maintain the quality of prints in print jobs.

The control unit may be one which stops the print job and makes the calibration unit calibrate when the number of printed pages since the latest calibration becomes equal to a predetermined calibration number during the print job.

The control unit may be one which makes the calibration unit carry out calibration after a print job when a number of printed pages since the latest calibration enters a range of calibration and makes the calibration unit carry out calibration before printing in the above-described manner.

The present invention enables better optimization of the timing of calibrations. Because the optimization contributes to reducing the frequency of calibration during printing jobs more effectively, it makes it possible to maintain the quality of prints in print jobs.

The present invention provides a recording medium on which is recorded a program for controlling the calibration of an image forming device, that program including a step of counting a number of printed pages since the latest calibration at the end of a print job and a step of ordering calibration when the number of printed pages enters a predetermined range for calibration.

The program may include a step of stopping the print job and ordering calibration when the number of printed pages since the latest calibration becomes equal to the predetermined calibration number during the print job.

The present invention provides a recording medium on which is recorded a program for controlling the calibration of an image forming device, that program including a step of determining a number of pages needed to be printed in the print job, a step of counting a total number which is the number of pages and a number of printed pages since the latest calibration and a step of ordering calibration before printing when the total number becomes greater than a predetermined calibration number.

The program may include a step of stopping the print job and ordering calibration when the number of printed pages after the latest calibration becomes equal to the predetermined calibration number during the print job.

The program may further include a step of counting a number of printed pages since the latest calibration at the end of a print job and a step of ordering calibration when the number of printed pages enters a predetermined range for calibration.

### BRIEF DESCRIPTION OF THE DRAWINGS

FIG. 1 is a block diagram which shows the structure of an embodiment of the present invention.

FIG. 2 is a flowchart which shows a series of operations of the device shown in FIG. 1.

FIG. 3 is a flowchart which shows a series of operations of the device shown in FIG. 1.

FIG. 4 is a modified example of the flow chart shown in FIG. 2.

### DETAILED DESCRIPTION OF THE INVENTION

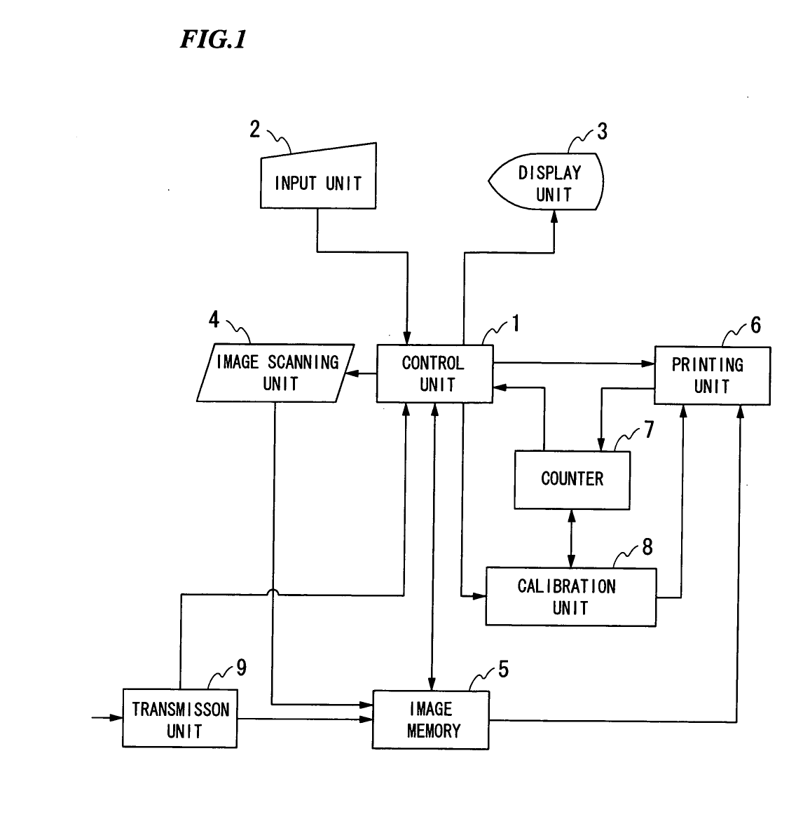

An explanation on an image forming device which is an embodiment of the present invention is presented, referring to FIGS. 1 to 3. FIG. 1 is a block diagram which shows the structure of the embodiment. The image forming device shown in FIG. 1 is a multi-functional device which has a copying function, printing function, facsimile sending and receiving function, and image scanning function. In FIG. 1, reference numeral 1 indicates a control unit which controls overall processing operation of the image forming device. Reference numeral 2 indicates an input unit consisting of a touch-sensitive panel, numeric keypad, or function keys. Reference numeral 3 indicates a display unit which consists of a liquid crystal display or other displaying device. Reference numeral 4 indicates an image scanning unit which has a color charge-coupled device and scans an original image. Reference numeral 5 indicates an image memory which stores image data scanned by the image scanning unit 4 or based on the data sent from a host computer. Reference numeral 6 indicates a printing unit which prints based on the data stored in the image memory 5. Reference numeral 7 indicates a counter which counts the number of pages printed by printing unit 6. Reference numeral 8 indicates a calibration unit which carries out calibration of the printing unit 6 when a number counted by the counter 7 becomes equal to the determined number for calibration, and resets the number of the counter 7 to zero after each calibration. Reference numeral 9 indicates a transmission unit which receives data to be printed from a host computer when the image forming device works as a printer.

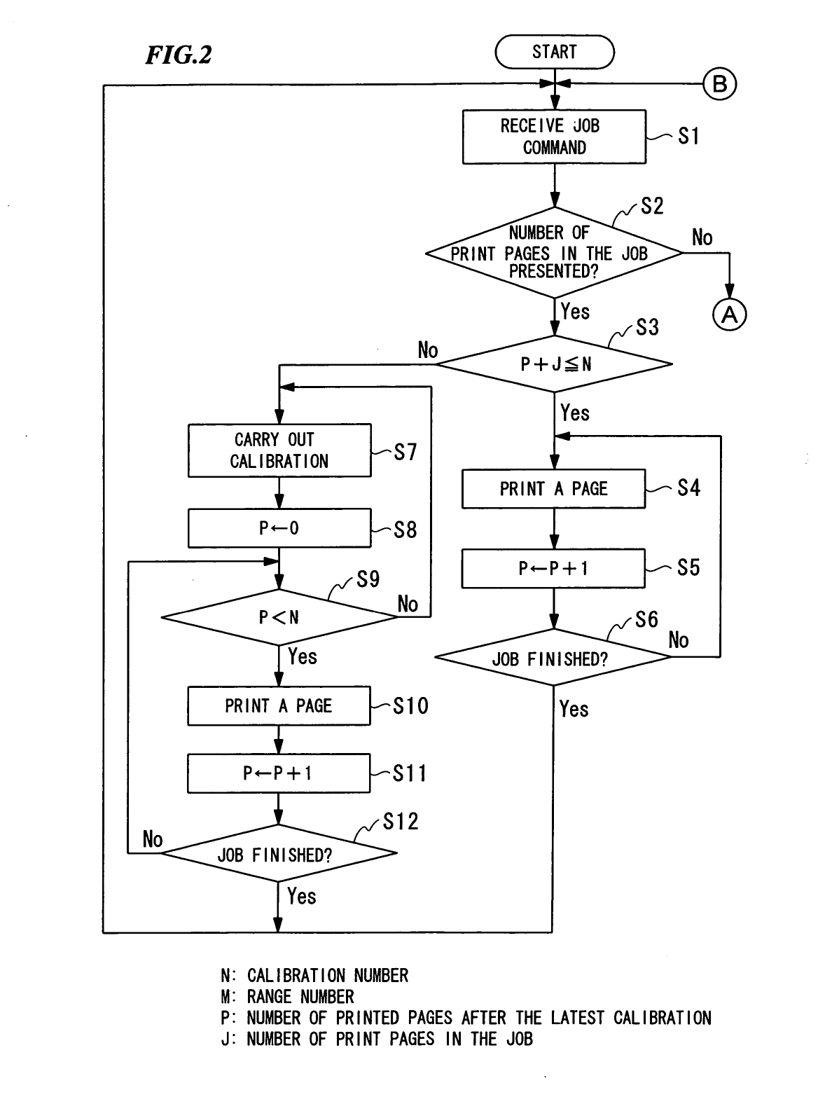

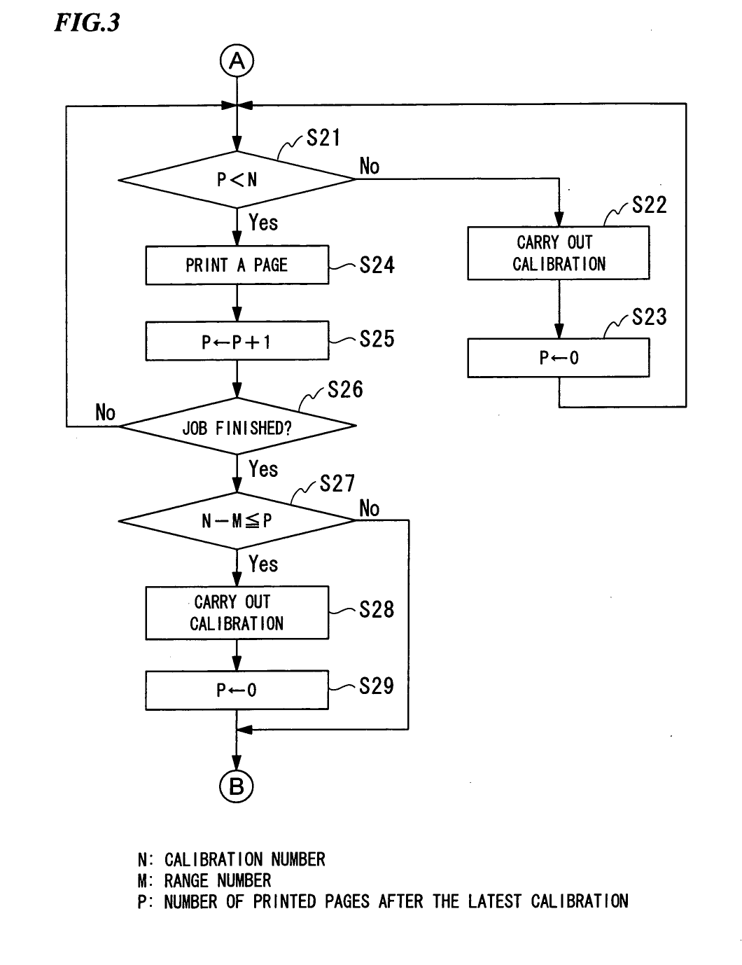

Next, an explanation for the letters which show the values used in FIG. 2 and FIG. 3 is presented before explaining operations to optimize the timing of calibration. Value N means the predetermined value memorized in the image forming device. When the number of printed pages since the latest calibration becomes equal to N, the device needs calibration. N is called the “calibration number” and it is assumed that N is 80 in this embodiment. Value M means a value to make the calibration number N have some range. M is called the “range number” and it is assumed that M is 10 in this embodiment. Therefore, the calibration range in this embodiment is from 70 (N minus M) to 80 (N). Value P means the number of printed pages since the latest calibration and P is equal to the number counted by the counter 7. Value J means the number of pages needed to be printed in the print job. When the image forming device is used as a copying machine, J equals the number of original images times the number of copy sets, and when the image forming device is used as a printer, J equals the number of print pages times the number of sets to be printed. But J is not always clear when using as a printer, and this is also true in the case in which the device scans each image when copying because the number of original images is not always clear. Therefore, in some cases, J is unknown before carrying out the print job.

An explanation of the actions for controlling the timing of calibration is presented. The control unit 1 receives the command to carry out the print job (step S1). The command corresponds to the user's pressing a start key of the input unit 2 after placing an original image on the scanning table, or the control unit 1 receiving data to be printed via the transmission unit 9.

Then the control unit 1 determines whether value J is present or not (step S2). In the case in which J is present, the control unit 1 determines whether the sum of J added to the value P of the counter 7 (the number of printed pages since the latest calibration) is equal to or less than the calibration number N or not (step S3). After the determination, if the inequality P+J≦N is satisfied, the control unit outputs the command to print to the printing unit 6. The printing unit 6 reads out the data for a sheet of paper from the image memory 5, carries out the printing for a sheet of paper (step S4) and adds one to P of the counter 7 (step S5). Then the control unit 1 determines whether the print job ends or not (step S6), and repeats printing operation until the job ends, and waits for a command for the next print job.

On the other hand, if the inequality P+J≦N is not satisfied in step S3, the control unit 1 outputs the command to calibrate to the calibration unit 8. The calibration unit 8 carries out calibration (step S7) and resets the counter 7 to zero after the calibration (step S8).

Then the control unit 1 compares P of the counter 7 with the calibration number N and determines whether N is greater than P or not (step S9). This determination is carried out to calibrate during a print job when J is greater than N. After the determination, if the inequality P<N is not satisfied, calibration is carried out (step S7, S8). If the inequality P<N is satisfied, the control unit 1 outputs the command to print to the printing unit 6. The printing unit 6 reads out the data for a sheet of paper from the image memory 5, carries out the printing for a sheet of paper (step S10) and adds one to P of the counter 7 (step S11). Then the control unit 1 determines whether the print job ends or not (step S12), and repeats printing operation until the job ends.

An explanation of the actions for controlling the timing of calibration in the case in which value J is not present is presented. The control unit 1 compares P of the counter 7 with the calibration number N and determines whether N is greater than P or not (step S21). This determination is carried out to calibrate during a print job when J is greater than N. After the determination, if the inequality P<N is not satisfied, the control unit 1 outputs the command to calibrate to the calibration unit 8. The calibration unit 8 carries out calibration of the printing unit 6 (step S22) and resets the counter 7 to zero after the calibration (step S23). If the inequality P<N is satisfied, the control unit 1 outputs the command to print to the printing unit 6. The printing unit 6 reads out the data for a sheet of paper from the image memory 5, carries out the printing for a sheet of paper (step S24) and adds one to P of the counter 7 (step S25). Then the control unit 1 determines whether the print job ends or not (step S26), and repeats printing operation until the job ends, carrying out the determination of step S2 1.

After the end of the print job, the control unit 1 compares P of the counter 7 with the lowest number in the calibration range (N minus M) and determines whether the inequality N−M≦P (step S27) is satisfied or not. If the inequality N−M≦P is satisfied the control unit 1 outputs the command to calibrate to the calibration unit 8. The calibration unit 8 carries out calibration of the printing unit 6 (step S28) and resets the counter 7 to zero after the calibration (step S29). The control unit 1 waits for a command for the next print job after the calibration. If the inequality N−M≦P is not satisfied the control unit 1 waits for a command for the next print job without calibration.

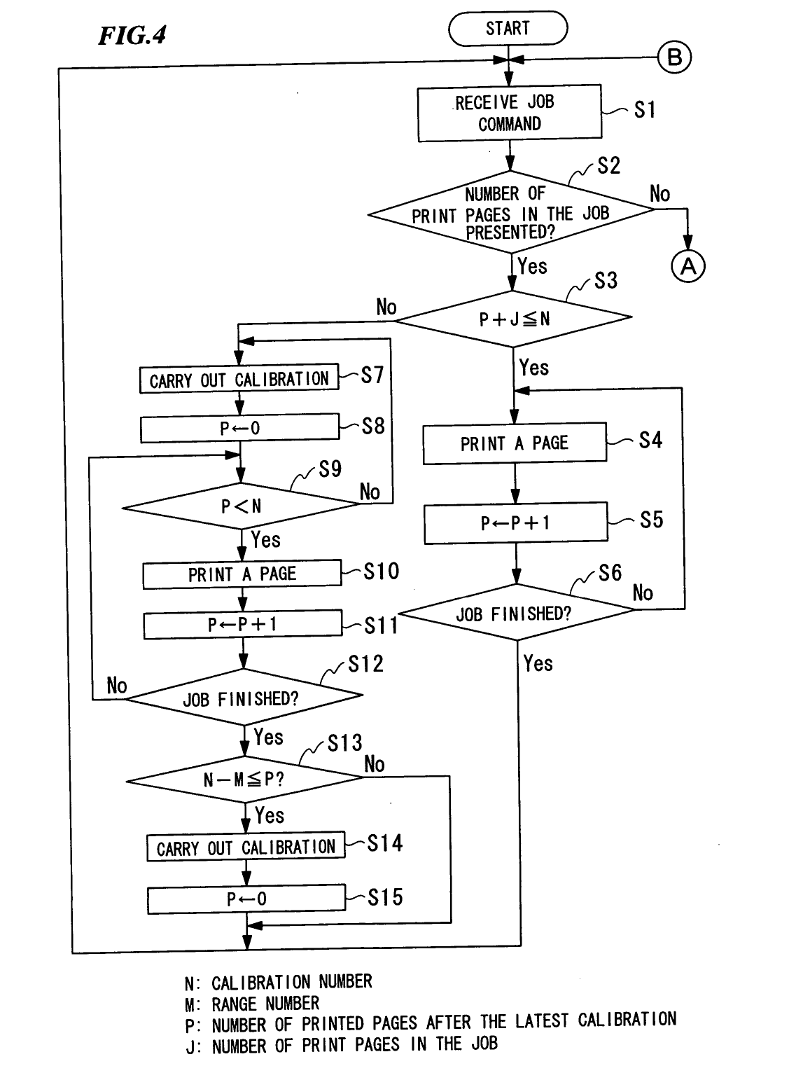

As shown in FIG. 4, the control unit 1 may carry out the calibration control of steps S13 to S15, which have the same processes as steps S27 to S29 also in a case where the printing number J of the print job is present. This control contributes to reducing the frequency of calibrations during print jobs when the printing number of the next print job after the print job is not present.

Because this embodiment of the present invention is set to carry out calibration after a print job under the condition that the value P enters a predetermined calibration range (from N minus M to N), it enables optimization of the timing of calibration. Also, because this embodiment of the present invention is set to carry out calibration before a print job under the condition that the sum of value J added to value P becomes greater than the predetermined calibration number N, it further contributes to the optimization of the timing of calibration. Since these effects are able to reduce the frequency of calibration during print jobs, it makes it possible to preserve the quality of prints in print jobs.

The present invention may have a setting unit for setting the calibration number N and the range number M with reference to the collected values about an average number of printed pages for print jobs, the largest in print jobs and other related parameters which are collected inside the image forming device. In this case, it makes it possible to carry out calibration more suitable to the respective conditions of using the device.

The control for calibration may be carried out by recording a program for carrying out the functions of the control unit 1 in a recording medium which is readable by computers, making a computer system read the program recorded in the recording medium, and making the computer system execute the program. The phrase “computer system” includes operating systems and hardware such as that of peripherals. The phrase “a medium which is readable by computers” means a flexible disc, magneto optical disc, ROM (read only memory), CD-ROM and other movable media, or memory device such as a hard disk contained in the computer system. The phrase “a medium which is readable by computers” also includes media which maintain the program for certain period of time, such as volatile memory (RAM) inside a computer system which works as a server or client when the program is sent via a network such as the Internet or a communication line such as phone line.

The program may be sent from a computer system which has the program in memory to another computer system via transmission media or by a transmitted signal in the transmission media. The phrase “transmission media” means media which have a function to transmit information such as the Internet (communication network) of a phone line (communication line). The program may be one to carry out a part of the function of the control unit 1, and the program may be a difference file (difference program) which enables the computer system to carry out the function of the control unit 1 by working together with a program recorded in the computer system.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

What is claimed is:

1. An image forming device comprising:
a printing unit which carries out a print job;
a calibration unit which calibrates the printing unit; and
a control unit which makes the calibration unit calibrate after an end of the print job under the condition that the number of printed pages since a latest calibration enters a predetermined calibration range.

2. The image forming device according to claim 1, wherein the control unit stops the print job and makes the calibration unit calibrate when the number of printed pages since the latest calibration becomes equal to a predetermined calibration number during the print job.

3. An image forming device comprising:
a printing unit which carries out a print job;
a calibration unit which calibrates the printing unit;
a determining unit which determines a number of pages needed to be printed in the print job; and
a control unit which makes the calibration unit calibrate before printing when a sum of the number of pages needed to be printed in the print job added to the number of printed pages since a latest calibration becomes greater than a predetermined calibration number.

4. The image forming device according to claim 3, wherein the control unit stops the print job and makes the calibration unit calibrate when the number of printed pages since the latest calibration becomes equal to the predetermined calibration number during the print job.

5. The image forming device according to claim 3, wherein the control unit makes the calibration unit calibrate after an end of the print job under the condition that the number of printed pages since the latest calibration enters a predetermined calibration range.

6. A recording medium on which is recorded a program for controlling the calibration of an image forming device, the program comprising:
a step of counting a number of printed pages since a latest calibration at an end of a print job; and
a step of ordering calibration when the number of printed pages enters a predetermined range for calibration.

7. The recording medium according to claim 6, the program further comprising;
a step of stopping the print job and ordering calibration when the number of printed pages since the latest calibration becomes equal to the predetermined calibration number during the print job.

8. A recording medium on which is recorded a program for controlling calibration of an image forming device, the program comprising:
a step of determining a number of pages needed to be printed in a print job;
a step of determining a sum of the number of pages and a number of printed pages since a latest calibration; and
a step of ordering calibration before printing when the total number becomes greater than a predetermined calibration number.

9. The recording medium according to claim 8, the program further comprising;
a step of stopping the print job and ordering calibration when the number of printed pages since the latest calibration becomes equal to the predetermined calibration number during the print job.

10. The recording medium according to claim 8, the program further comprising;
a step of counting a number of printed pages since the latest calibration at an end of the print job; and
a step of ordering calibration when the number of printed pages enters a predetermined range for calibration.
